(19) United States
(12) Patent Application Publication
(10) Pub. No.: US 2017/0283964 A1
(43) Pub. Date: Oct. 5, 2017

(54) OXYGEN-CONSUMING ELECTRODE WHICH CONTAINS CARBON NANOTUBES AND METHOD FOR PRODUCING SAME

(71) Applicant: Covestro Deutschland AG, Leverkusen (DE)

(72) Inventors: Andreas BULAN, Langenfeld (DE); Jürgen KINTRUP, Leverkusen (DE)

(21) Appl. No.: 15/510,259

(22) PCT Filed: Aug. 28, 2015
(86) PCT No.: PCT/EP2015/069726

§ 371 Date: Mar. 10, 2017

(30) Foreign Application Priority Data
Sep. 12, 2014 (DE) 10 2014 218 368.5

(51) Int. Cl. C25B 11/03; H01M 4/88; C25B 11/04; H01M 8/083; H01M 12/06; C25B 1/46; H01M 4/86; H01M 4/96

(52) U.S. Cl. CPC C25B 11/035; H01M 4/8605; H01M 4/8896; H01M 4/96; H01M 8/083; H01M 12/06; C25B 1/46; C25B 11/0405; C25B 11/0426; C25B 11/0447

(57) ABSTRACT

The invention relates to an oxygen-consuming electrode, in particular for use in chloralkali electrolysis, comprising a catalyst coating based on carbon nanotubes, and to an electrolysis device. The invention further relates to a method for producing said oxygen-consuming electrode and to the use thereof in chloralkali electrolysis or fuel cell technology.

The invention relates to an oxygen-depolarized electrode, in particular for use in chloralkali electrolysis, having a novel electrocatalyst coating and also to an electrolysis apparatus. The invention further relates to a process for producing the oxygen-depolarized electrode and also to its use in chloralkali electrolysis or fuel cell technology.

The invention proceeds from oxygen-depolarized electrodes which are known per se and are configured as gas diffusion electrodes and usually comprise an electrically conductive support and a gas diffusion layer having a catalytically active component.

Oxygen-depolarized electrodes are a form of gas diffusion electrodes. Gas diffusion electrodes are electrodes in which the three states of matter, viz. solid, liquid and gaseous, are in contact with one another and the solid, electron-conducting catalyst catalyzes an electrochemical reaction between the liquid phase and the gaseous phase. The solid electrocatalyst is usually present in a porous film having a thickness in the range from about 200 μm to 500 μm.

Various proposals for operating the oxygen-depolarized electrodes in electrolysis cells of industrial size are known in principle from the prior art. The basic idea here is to replace the hydrogen-evolving cathode of the electrolysis (for example in chloralkali electrolysis) by the oxygen-depolarized electrode (cathode). An overview of the possible cell design and solutions may be found in the publication by Moussallem et al “Chlor-Alkali Electrolysis with Oxygen Depolarized Cathodes: History, Present Status and Future Prospects”, J. Appl. Electrochem. 38 (2008) 1177-1194.

The oxygen-depolarized electrode, hereinafter also referred to as ODE for short, has to meet a series of fundamental requirements in order to be usable in industrial electrolyzers. Thus, the electrocatalyst and all other materials used have to be chemically stable toward the alkali metal hydroxide solution used, e.g. a sodium hydroxide solution having a concentration of about 32% by weight, and toward pure oxygen at a temperature of typically 80-90° C. A high measure of mechanical stability is likewise required, so that the electrodes can be installed and operated in electrolyzers having an area of usually more than 2 m² (industrial size). Further properties are: a high electrical conductivity, a high internal surface area and a high electrochemical activity of the electrocatalyst. Suitable hydrophobic and hydrophilic pores and an appropriate pore structure for conduction of gas and electrolyte are likewise necessary, as is impermeability so that, for example, gas space and liquid space remain separated from one another in an electrolyzer. Long-term stability and low production costs are further particular requirements which an industrially usable oxygen-depolarized electrode has to meet.

A further development direction for utilization of the ODE technology in chloralkali electrolysis is to place the ion-exchange membrane which separates the anode space from the cathode space in the electrolysis cell directly on the ODE. A sodium hydroxide solution gap is not present in this arrangement. This arrangement is also referred to as zero gap arrangement in the prior art. This arrangement is usually also employed in fuel cell technology. A disadvantage here is that the sodium hydroxide solution formed has to be conveyed through the ODE to the gas side and subsequently flows downward on the ODE. Here, blockage of the pores in the ODE by the sodium hydroxide solution or crystallization of sodium hydroxide in the pores must not occur. It has been found that very high sodium hydroxide concentrations can arise here too, as a result of which the ion-exchange membrane is not stable in the long term to these high concentrations (Lipp et al, J. Appl. Electrochem. 35 (2005) 1015—Los Alamos National Laboratory “Peroxide formation during chlor-alkali electrolysis with carbon-based ODC”).

The use of inexpensive carbon materials such as carbon black or graphite as support material has to be avoided completely, in particular in the reduction of oxygen in an alkaline medium, because these generally promote the reaction according to reaction route (I) and thus lead to greatly reduced lives of the electrodes and to current yield losses (O. Ichinose et al. “Effect of silver catalyst on the activity and mechanism of a gas diffusion type oxygen cathode for chloralkali electrolysis”, Journal of Applied Electrochemistry 34: 55-59 (2004)).

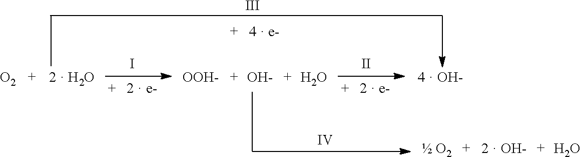

A disadvantage of the reduction of oxygen in an alkaline medium, where “in an alkaline medium” means, for example, a concentrated, in particular 32% strength by weight, sodium hydroxide solution, using an electrocatalyst, e.g. a catalyst in which silver supported on carbon black is present, and a temperature in the range from 60° C. to 90° C. is that the hydrogen peroxide formed as an intermediate degrades the carbon of the carbon black, resulting in formation of cracks in the electrode and to mechanical instability of the electrode and the electrode becoming unusable. Due to this “carbon corrosion”, the supported electrode catalyst likewise becomes detached from the support and the electrocatalyst thus becomes unusable.

It is likewise known (see O. Ichinose et al.) that the transfer of two electrons to oxygen can be avoided when silver is added to the carbon black; here, the step transferring four electrodes is preferred.

Similar effects also occur in the case of electrodes which are loaded with platinum and contain carbon black (L. Lipp “Peroxide formation in a zero-gap chlor-alkali cell with an oxygen-depolarized cathode”, Journal of Applied Electrochemistry 35:1015-1024 (2005)). It is also disclosed that part of the hydrogen peroxide formed can be reduced further to the desired hydroxide ions by application of higher voltages and/or higher current densities. The possibility of the sequence of reactions according to reaction route (I) and (II) is thus described. However, since the reaction according to reaction route (I) takes place, the reaction according to reaction route IV likewise cannot be prevented, which in turn leads to a reduction in the yield of hydroxide ions. The process variants disclosed (see L. Lipp et al., O. Ichinose et al.) thus have the same economic and technical disadvantages.

Carbon nanotubes (CNTs) have been generally known to those skilled in the art at least since they were described in 1991 by Iijima 5 (S. Iijima, Nature 354, 56-58, 1991). Since then, the term carbon nanotubes has referred to cylindrical bodies comprising carbon and having a diameter in the range from 3 to 80 nm and a length which is a multiple of, at least 10 times, the diameter. Furthermore, these carbon nanotubes are characterized by layers of ordered carbon atoms, with the carbon nanotubes normally having a core which differs in terms of the morphology. Synonyms for carbon nanotubes are, for example, “carbon fibrils” or “hollow carbon fibers” or “carbon bamboos” or (in the case of rolled structures) “nanoscrolls” or “nanorolls”.

A further development in processes for the reduction of oxygen is the use of nitrogen-containing carbon modifications (P. Matter et al., “Oxygen reduction reaction activity and surface properties of nanostructured nitrogen-containing carbon”, Journal of Molecular Catalysis A: Chemical 264: 73-81 (2007)). Here, catalytic activity for the reduction of oxygen is obtained by catalytic deposition of vapors of acetonitrile on support materials such as silicon dioxide, magnesium oxide which in turn contain iron, cobalt or nickel as catalytically active component. The process for the reduction of oxygen is characterized in that it is carried out in a 0.5 molar sulfuric acid solution.

WO 2010069490 A1 describes the use of nitrogen-modified carbon nanotubes (NCNTs) for the reduction of oxygen in an alkaline medium. Here, no noble metal-containing catalysts are used. However, experiments have shown that the NCNT-based electrodes do not have a satisfactory long-term stability.

DE102009058833 A1 describes a process for producing nitrogen-modified CNTs, with from 2 to 60% by weight of metal nanoparticles having an average particle size in the range from 1 to 10 nm being present on the surface of the NCNTs. A disadvantage here is that the production method is very complicated.

Various methods which can fundamentally be divided into wet processes and dry processes are known for producing gas diffusion electrodes. In the dry process, e.g. as described in DE102005023615A1, the catalyst is milled together with a polymer, frequently PTFE, to give a mixture and the mixture is subsequently applied to a mechanical support element, for example silver or nickel mesh. The powder is subsequently compacted together with the support to form an electrode by pressing, e.g. by means of a roller compactor.

In contrast, in the wet process, e.g. as described in EP2397578A2, a suspension of catalyst and polymer component is produced. This is applied to the support material and subsequently dried and sintered (I. Moussallem, J. Jörissen, U. Kunz, S. Pinnow, T. Turek, “Chlor-alkali electrolysis with oxygen depolarized cathodes: history, present status and future prospects”, J Appl. Electrochem. 2008, 38, 1177-1194).

It was an object of the invention to provide a carbon-based gas diffusion electrode and a process for the production thereof, by means of which the reduction of oxygen can be carried out both in an acidic electrolyte (pH<6) and also in an alkaline electrolyte (pH>8) without hydrogen peroxide being formed, the reaction occurs with high current yields and the electrode has a satisfactory long-term stability.

It has surprisingly been found that the use of specific carbon nanotubes (CNTs) which are mixed with PTFE by the present process according to the invention and the powder mixture obtained is subsequently pressed together with a support element leads to electrodes having long-term stability.

The invention provides a process for producing a gas diffusion electrode for the reduction of oxygen, where the gas diffusion electrode has at least one sheet-like electrically conductive support element and a gas diffusion layer applied to the support element and an electrocatalyst, characterized in that the gas diffusion layer is formed by a mixture of carbon nanotubes and fluoropolymer, in particular PTFE, and in that a mixture of carbon nanotubes and fluoropolymer is applied in powder form to the support element and compacted, with the carbon nanotubes forming the electrocatalyst and being substantially free of nitrogen constituents.

Here, substantially free of nitrogen constituents means that the proportion of nitrogen in the form of nitrogen chemically bound to the CNTs is less than 0.5% by weight, preferably less than 0.3% by weight, particularly preferably less than 0.2% by weight. The nitrogen content can be determined by means of a commercial CHN analyzer based on the principle of combustion of the sample at 950° C. in pure oxygen and detection of the nitrogen given off by means of a thermal conductivity detector.

For the purposes of the invention and as in the prior art, the term carbon nanotubes is used to refer to usually mainly cylindrical carbon tubes having a diameter in the range from 1 to 100 nm and a length which is a multiple of the diameter. These tubes consist of one or more layers of ordered carbon atoms and have a core which differs in terms of the morphology. These carbon nanotubes are also referred to as, for example, “carbon fibrils” or “hollow carbon fibers”.

Carbon nanotubes have been known for a long time in the technical literature. Although Iijima (publication: S. Iijima, Nature 354, 56-58, 1991) is generally being credited with being the discoverer of carbon nanotubes (also referred to as nanotubes or CNT for short), these materials, in particular fibrous graphite materials having a plurality of graphene layers, have been known since the 1970s and early 1980s. Tates and Baker (GB 1469930A1, 1977 and EP 0056 004A2, 1982) first described the deposition of very fine, fibrous carbon from the catalytic decomposition of hydrocarbons. However, the carbon filaments produced on the basis of short-chain hydrocarbons were not characterized further in respect of their diameter.

The production of carbon nanotubes having diameters of less than 100 nm was described for the first time in EP 205 556B1 and WO 86/03455A1. These carbon nanotubes are produced using light (i.e. short- and medium-chain aliphatic or monocyclic or bicyclic aromatic) hydrocarbons and an iron-based catalyst over which carbon-carrying compounds are decomposed at a temperature above 800-900° C.

The methods known today for producing carbon nanotubes encompass electric arc, laser ablation and catalytic processes. In many of these processes, soot, amorphous carbon and fibers having large diameters are formed as by-product. Among the catalytic processes, a distinction can be made between deposition of introduced catalyst particles and the deposition of metal centers which are formed in-situ and have diameters in the nanometer range (known as flow processes). In the production by catalytic deposition of carbon from hydrocarbons which are gaseous under the reaction conditions (hereinafter CCVD; catalytic carbon vapor deposition), acetylene, methane, ethane, ethylene, butane, butane, butadiene, benzene and further carbon-containing starting materials have been mentioned as possible carbon carriers.

The catalysts generally comprise metals, metal oxides or decomposable or reducible metal components. As possible metals for catalysts, the prior art makes mention by way of example of Fe, Mo, Ni, V, Mn, Sn, Co, Cu and others. The individual metals usually do have, even alone, a tendency to catalyze the formation of carbon nanotubes. However, according to the prior art, high yields of carbon nanotubes and small proportions of amorphous carbon are advantageously achieved using metal catalysts which contain a combination of the abovementioned metals.

Particularly advantageous catalyst systems are based, according to the prior art, on combinations containing Fe, Co or Ni. The formation of carbon nanotubes and the properties of the tubes formed depend in a complex way on the metal component or combination of a plurality of metal components used as catalyst, the support material used and the interaction between catalyst and support, the feed gas and feed gas partial pressure, admixture of hydrogen or further gases, the reaction temperature and the residence time and the reactor used. Optimization is a particular challenge for an industrial process.

It may be remarked that the metal component used in CCVD and referred to as catalyst is consumed during the course of the synthesis process. This consumption is attributable to deactivation of the metal component, e.g. due to deposition of carbon on the entire particle, which leads to complete covering of the particle (this is known as “encapping” to those skilled in the art). Reactivation is generally not possible or not economically feasible. Often, only not more than a few grams of carbon nanotubes are obtained per gram of catalyst, with the catalyst here encompassing the totality of support and active catalyst metal(s) used. Owing to the indicated consumption of catalyst and owing to the economic outlay involved in separating the catalyst residue from the finished carbon nanotube product, a high yield of carbon nanotubes based on the catalyst used represents an important requirement which catalyst and process have to meet.

Usual structures of carbon nanotubes are those of the cylinder type (tubular structure). Among cylindrical structures, a distinction is made between single-wall carbon nanotubes (SWCNT) and multiwall carbon nanotubes (MWCNT). Conventional processes for producing these are, for example, electric arc processes (arc discharge), laser ablation, chemical vapor deposition (CVD process) and catalytic chemical vapor deposition (CCVD).

Such cylindrical carbon nanotubes can likewise be produced by an electric arc process. Iijima (Nature 354, 1991, 56-8) reports the formation of carbon tubes which consist of two or more graphene layers which are rolled up to form a seamlessly closed cylinder and are nested in one another in an electric arc process. Depending on the rolling-up vector, chiral and achiral arrangements of the carbon atoms along the longitudinal axis of the carbon fiber are possible.

The process described in WO 2009/036877A2 makes it possible to produce, for example, carbon nanotubes which have a scroll structure in which one or more graphite layers consisting of two or more superposed graphene layers form a rolled structure.

Further known structures of carbon nanotubes are described in a review article by Milne et al. (Milne et al., Encyclopedia of Nanoscience and Nanotechnology, 2003, Volume X, Pp. 1-22; ISBN 1-58883-001-2). These structures are the “herringbone” structure, the cup-stacked structure and the stacked structure, the bamboo structure and the platelet structure. Carbon nanofibers can likewise be produced by means of electrospinning of polyacrylonitrile and subsequent graphitization (Jo et al., Macromolecular Research, 2005, Vol. 13, pp. 521-528).

Although all the abovementioned types of carbon nanotubes can in principle be employed for the novel production process, preference is given to using carbon nanotubes which have a scroll structure as described above. An advantage of these specific CNT types is their formation of agglomerates in the micron range, which can be processed with fewer problems than powder. The use of such CNT agglomerates is therefore preferred in the production of gas diffusion electrodes by the dry process.

The nitrogen-containing carbon nanotubes known from the prior art lead, when processed with PTFE, to gas diffusion electrodes which in practical operation displayed a usable cell voltage when operated as oxygen-depolarized electrode in chloralkali electrolysis for only a few hours and then rapidly led to a tremendous voltage increase. Such an electrode material based on nitrogen-containing carbon nanotubes is unusable in practice.

In a preferred process, the mixture of carbon nanotubes and fluoropolymer is applied as powder mixture to the support element.

As preferred material of the carbon nanotubes, use is made of carbon nanotubes in the form of an agglomerate, with at least 95% by volume of the agglomerate particles having an external diameter in the range from 30 μm to 5000 μm, preferably from 50 μm to 3000 μm and particularly preferably from 100 μm to 1000 μm.

The external diameter is, for example, determined by means of laser light scattering (in accordance with ISO 13320:2009) on an aqueous dispersion without use of ultrasound, for which purpose the measured cumulated volume distribution curve is employed.

Such a material is easier to handle in dry processing than more finely divided CNT powder. It is also advantageous for the agglomerates to be maintained during the production of the powder mixture. In a preferred embodiment, the finished electrode therefore also has the CNT agglomerates in the abovementioned diameter distribution.

In a further preferred embodiment of the process, a pulverulent fluoropolymer having an average particle size (d50) in agglomerated form of from 100 μm to 1 mm, preferably from 150 μm to 0.8 mm and particularly preferably from 200 μm to 400 μm, is used as fluoropolymer, in particular polytetrafluoroethylene (PTFE).

The particle size in agglomerated form is determined, for example, by means of laser light scattering on a dry sample dispersed in air or inert gas. The d50 (also median value) of the measured cumulated volume distribution curve is employed as the average particle size.

The processing of carbon nanotubes and fluoropolymer as powder is preferably carried out by dry mixing of the powders.

As polymer component, particular preference is given to using a high molecular weight polytetrafluoroethylene (PTFE), e.g. PTFE powder from Dyneon, grade 2053, having a particle size d50 of about 230 μm. However, it is also possible to use other PTFE powders.

The novel gas diffusion electrode preferably contains a mixture of carbon nanotubes and fluoropolymer, in particular PTFE, comprising from 1 to 70% by weight, preferably from 5 to 65% by weight, particularly preferably from 10 to 65% by weight, of PTFE and 99-30% by weight, preferably 95-35% by weight, particularly preferably from 90 to 35% by weight, of carbon nanotubes.

The mixing process is preferably carried out in two phases: a first phase with low shear at low temperature and a second phase at high shear and elevated temperature. This preferred mode of operation is characterized in that the dry mixing in the first phase is carried out until a homogeneous premix is obtained, with the temperature of the mixture being not more than 25° C., preferably not more than 20° C.

The preferred procedure is, in the second phase, particularly carried out using mixers which have fast-running beating tools, e.g. the mixer from Eirich, model R02, equipped with a star whirler as mixing element which is operated at a speed of rotation of 5000 rpm. In contrast to the prior art, e.g. in DE 102005023615 A, the mixing process in the second phase, after attaining a homogeneous premix from the first phase, should be carried out at a temperature of more than 30° C. in the preferred process. Preference is given to a mixing temperature which is from 30° C. to 80° C., particularly preferably from 35° C. to 70° C., very particularly preferably from 40° C. to 60° C. Since no heating occurs during the mixing process, the powder mixture should be heated before introduction into the mixer and/or the mixing vessel should be heated to the required temperature. Preference is given to using mixers which have a double-walled mixing vessel.

The powder mixture produced is subsequently sprinkled onto the support element, for example using the procedure described in DE102005023615A.

The support element of the ODE can be a mesh, nonwoven, foam, woven fabric, braid or expanded metal. The support can consist of carbon fibers, nickel, silver or nickel coated with noble metal, with the noble metal preferably being selected from one or more of the series: silver, gold and platinum.

The sprinkling of the powder mixture onto the support element can, for example, occur through a sieve. A frame-like template is particularly advantageously placed on the support element, with the template preferably being selected so that it just surrounds the support element. As an alternative, the template can also be selected so as to be smaller than the area of the support element. In this case, an uncoated margin of the support element remains free of electrochemically active coating after sprinkling-on of the powder mixture and pressing together with the support element. The thickness of the template can be selected according to the amount of powder mixture to be applied to the support element. The template is filled with the powder mixture. Excess powder can be removed by means of a scraper. The template is then removed. However, a layer thickness of typically more than 2 mm is produced here, in contrast to the prior art. Thus, layer thicknesses of the abovementioned powder mixture of preferably from 1 to 10 mm, preferably from 3 to 8 mm, are produced by the novel process.

The layers are, for example, produced by means of a template, and excess powder is removed by means of scrapers.

The powder layer is subsequently compacted in particular by a factor of from 2 to 10. The compaction ratio describes the ratio of the thickness of the compacted CNT-PTFE powder mixture on the support element to the bulk density of the powder mixture. The support element is not taken into account in the calculation.

The bulk density of the powder mixture is, for example, determined as follows. The powder mixture which has been sieved through a sieve having a mesh opening of 1 mm is introduced into a 500 ml measuring cylinder and subsequently weighed. The bulk density is calculated from the volume and the mass. Here, the powder is not loaded mechanically, and the measuring cylinder is also not firmly set down or mechanically loaded, so that no compaction or densification can occur.

The compaction of the powder mixture which has been sprinkled on the support element and struck off can be effected by pressing or by roller compacting. The preferred method is roller compacting. A particularly preferred process for producing the gas diffusion electrode is therefore characterized in that compaction is carried out by means of rollers, with the linear pressing force applied by the roller(s) used to the support element and sprinkled-on powder mixture preferably being from 0.1 to 1 kN/cm, preferably from 0.2 to 0.8 kN/cm.

Rolling is preferably carried out at a constant ambient temperature of the manufacturing rooms, in particular at a temperature of not more than 20° C.

The gas diffusion electrode can have the gas diffusion layer produced by compacting of the CNT/fluoropolymer powder mixture on one or both sides. The gas diffusion layer is preferably applied on one side to a surface of the support element.

The thickness of the gas diffusion electrode after compaction is in particular from 0.1 to 3 mm, preferably from 0.1 to 2 mm, particularly preferably from 0.1 to 1 mm.

The porosity of the ODE is from 70 to 90%. The porosity is calculated from the ratio of the solids volume to the empty volume in the gas diffusion electrode. Here, the solids volume of the gas diffusion electrode is calculated from the sum of the volumes of the components added. The volume of the gas diffusion electrode without the support element is determined from the density of the composition of the gas diffusion electrode. When the solids volume is subtracted from the volume of the gas diffusion electrode, the empty volume of the gas diffusion electrode is obtained. The ratio of empty volume to volume of the gas diffusion electrode gives the porosity.

The invention further provides a gas diffusion electrode for the reduction of oxygen, where the gas diffusion electrode has at least one sheet-like electrically conductive support element and a gas diffusion layer and electrocatalyst applied to the support element, characterized in that the gas diffusion layer consists of a mixture of carbon nanotubes and PTFE, with the carbon nanotubes and fluoropolymer having been applied in powder form to the support element and compacted and the carbon nanotubes forming the electrocatalyst.

Preference is given to a gas diffusion electrode obtained from a production process according to the invention as described above.

In a preferred embodiment of the gas diffusion electrode, the carbon nanotubes used in manufacture have a content of catalyst residues of the catalyst used for producing the carbon nanotubes, in particular of transition metals, particularly preferably of manganese and/or iron and/or cobalt, of less than 1% by weight, in particular less than 0.5% by weight, particularly preferably not more than 0.3% by weight. This is achieved, for example, by the CNT powders having a higher metal content being washed with acids and isolated before processing to form the powder mixture.

The invention therefore further provides for the use of the novel gas diffusion electrode for the reduction of oxygen in the presence of alkaline electrolytes, e.g. sodium hydroxide solution, in particular in an alkaline fuel cell, use in mains water treatment, for example for producing sodium hypochlorite as bleaching solution or use in chloralkali electrolysis, in particular for the electrolysis of LiCl, KCl or NaCl.

The novel ODE is particularly preferably used in chloralkali electrolysis and here particularly in the electrolysis of sodium chloride (NaCl).

The invention further provides an electrolysis apparatus, in particular for chloralkali electrolysis, having a novel gas diffusion electrode as described above as oxygen-depolarized cathode.

The invention is illustrated below by the examples, but without these constituting a restriction of the invention.

### EXAMPLES

### Example 1

The production of an electrode is described below.

15 g of a powder mixture, consisting of 40% by weight of PTFE powder Dyneon grade TF2053Z and 60% by weight of CNT powder (produced as described in WO 2009/036877A2, example 2), average agglomerate diameter about 450 μm (d50 by means of laser light scattering), bulk density about 200 g/l, content on residual catalyst (Co and Mn) about 0.64% by weight and a nitrogen content of 0.18% by weight, were premixed in a first phase at a temperature of about 19° C. to give a homogeneous mixture and then heated to 50° C. in a drying oven and introduced into a mixer from IKA which had been preheated to 50° C. The IKA mixer was equipped with a star whirler as mixing element and was operated at a speed of rotation of 15 000 rpm. The mixing time in the second phase of the mixing process was 60 seconds, with mixing being interrupted after every 15 seconds to detach mixed material on the wall. The temperature of the powder mixture after the second mixing phase was 49.6° C. Heating of the powder during the mixing process was not observed. The powder mixture was cooled to room temperature. After cooling, the powder mixture was sieved using a sieve having a mesh opening of 1.0 mm. The powder mixture had a bulk density of 0.0975 g/cm³.

The sieved powder mixture was subsequently applied to a mesh made of gilded nickel wires having a wire thickness of 0.14 mm and a mesh opening of 0.5 mm. Application was carried out with the aid of a 4 mm thick template, with the powder being applied using a sieve having a mesh opening of 1 mm. Excess powder projecting above the thickness of the template was removed by means of a scraper. After removal of the template, the support element with the applied powder mixture was pressed by means of a roller press at a pressing force of 0.45 kN/cm. The gas diffusion electrode was taken from the roller press. The density of the electrode without the support element was 0.5 g/cm³, giving a compaction ratio of 5.28. The thickness of the finished electrode was 0.6 mm.

The oxygen-depolarized cathode (ODC) produced in this way was installed in a laboratory electrolysis cell with an active area of 100 cm² and operated under the conditions of chloralkali electrolysis. An ion-exchange membrane from DuPONT, type N982WX, was used here. The sodium hydroxide gap between ODC and membrane was 3 mm. A titanium anode consisting of an expanded metal having a commercial DSA® Coating for chlorine production from Denora was used as anode. The cell voltage at a current density of 4 kA/m³, an electrolyte temperature of 90° C., a sodium chloride concentration of 210 g/l and a sodium hydroxide concentration of 32% by weight was on average 2.20 V. The experiment could be operated for 120 days without an increase in voltage.

### Example 2 Comparative Example—Carban Black—Support Element Silver Mesh

The production of the electrode was carried out as described in example 1, but Vulcan carbon black grade XC72R from Cabot was used instead of the CNTs.

The cell voltage was 2.20V at the beginning of the experiment and remained constant for 7 days. After the 7^{th} day, the cell voltage increased continuously by 16 mV every day. On the 19^{th} day of operation, the cell voltage was 2.40V. The used electrode displayed mechanical deformation resulting from swelling of the electrode coating. This means that this material does not have long-term stability.

### Example 3 Comparative Example—Use of Nitrogen-Doped Carbon Nanotubes

Nitrogen-modified carbon nanotubes NCNTs were produced by means of a catalyst as described in WO2007/093337A2 (example 1, catalyst 1), which was introduced into a fluidized-bed reactor (diameter 100 mm). 60 g of the catalyst and 200 g of NCNTs (from a preliminary experiment) were firstly introduced into the reactor and reduced at 750° C. in a stream of 27 liters/minute of hydrogen and 3 liters/minute of nitrogen for 30 minutes, before the hydrogen stream was switched off, the nitrogen stream was increased to 21.5 liters/minute and the introduction of pyridine at a feed rate of 30 g per minute was commenced at the same time and carried on for a time of 30 minutes, likewise at 750° C. After cooling, about 400 g of NCNTs having a nitrogen content of 5.1% by weight were obtained. Further NCNT materials were produced analogously, and a mixture of at least 2 NCNT production batches was subsequently produced and then used for electrode production.

These NCNTs having a nitrogen content of 5.1% by weight were processed instead of the CNTs by the process described above in example 1 to give an electrode. The potential of the half cell was 387 mV relative to the RILE. The potential of the electrode based on NCNT is obviously significantly lower than the potential of the corresponding electrode based on CNT (example 1).

### Example 4

For this example, use was made of a CNT material which had been produced in a similar way to the CNT material of example 1, with the difference that the material used for example 4 was specially cleaned in order to remove the residual content of catalyst from the fluidized-bed production. The purified CNT material had a residual content of CNT catalyst (Co and Mn) of 0.02% by weight. The CNTs used had an N content of 0.15% by weight. In a laboratory cell test, the ODC displayed an average cell voltage over 16 days of 2.18 V and the cell voltage was thus 20 mV below the cell voltage of an ODE produced from unpurified CNT material (example 1).

1.-21. (canceled)

22. A process for producing a gas diffusion electrode for the reduction of oxygen, where the gas diffusion electrode has at least one sheet-like electrically conductive support element and a gas diffusion layer applied to the support element and an electrocatalyst, wherein the gas diffusion layer is formed by a mixture of carbon nanotubes and a fluoropolymer, and wherein a mixture of carbon nanotubes and fluoropolymer is applied in powder form to the support element and compacted, with the carbon nanotubes forming the electrocatalyst and being substantially free of nitrogen constituents.

23. The process as claimed in claim 22, wherein the carbon nanotubes are in form of an agglomerate, where at least 95% by volume of the agglomerate particles have an external diameter in the range from 30 μm to 5000 μm.

24. The process as claimed in claim 22, wherein the fluoropolymer has an average particle size d50 in agglomerated form of from 100 μm to 1 mm.

25. The process as claimed in claim 22, wherein the mixture of carbon nanotubes and fluoropolymer is produced by dry mixing.

26. The process as claimed in claim 25, wherein the dry mixing is carried out in a first phase until a homogeneous premix is obtained, with the temperature of the material being mixed being not more than 25° C.

27. The process as claimed in claim 25, wherein the dry mixing is carried out in a second phase, after obtaining a homogeneous premix from the first phase, using mixing tools, with the temperature of the mixture being more than 30° C.

28. The process as claimed in claim 22, wherein compaction is carried out by means of rollers in a roller apparatus, with the linear pressing force exerted by the roller(s) used on the support element and the sprinkled-on powder mixture preferably being from 0.1 to 1 kN/cm.

29. The process as claimed in claim 22, wherein rolling is carried out at a constant ambient temperature of the manufacturing rooms, in particular at a temperature of not more than 20° C.

30. The process as claimed in claim 22, wherein the mixture of carbon nanotubes and fluoropolymer comprises from 1 to 70% by weight of PTFE and 99-30% of carbon nanotubes.

31. The process as claimed in claim 22, wherein the electrically conductive support element is a mesh, nonwoven, foam, woven fabric, braid or expanded metal.

32. The process as claimed in claim 22, wherein the support element consists of carbon fibers, nickel, silver or nickel coated with noble metal.

33. A gas diffusion electrode for the reduction of oxygen, where the gas diffusion electrode has at least one sheet-like electrically conductive support element and a gas diffusion layer and electrocatalyst applied to the support element, wherein the gas diffusion layer consists of a mixture of carbon nanotubes and PTFE, with the carbon nanotubes and fluoropolymer having been applied in powder form to the support element and compacted and the carbon nanotubes forming the electrocatalyst.

34. The gas diffusion electrode as claimed in claim 33, wherein the electrode has been produced by a process as claimed in claim 22.

35. The gas diffusion electrode as claimed in claim 33, wherein the mixture of carbon nanotubes and PTFE, contains from 1 to 70% of PTFE and 99-30% of carbon nanotubes.

36. The gas diffusion electrode as claimed in claim 33, wherein the electrode has a thickness of from 0.1 to 3 mm.

37. The gas diffusion electrode as claimed in claim 33, wherein the gas diffusion layer has been applied on one or both sides to the surfaces of the support element.

38. The gas diffusion electrode as claimed in claim 33, wherein the carbon nanotubes have a content of catalyst residues of the catalyst used for producing the carbon nanotubes of less than 1% by weight.

39. The gas diffusion electrode as claimed in claim 33, wherein the carbon nanotube powder is present as agglomerate, with at least 95% by weight of the agglomerate particles having an external diameter in the range from 30 μm to 5000 μm.

40. The gas diffusion electrode as claimed in claim 33, wherein the proportion of nitrogen in the form of nitrogen chemically bound to the carbon nanotubes is less than 0.5% by weight.

41. A method comprising utilizing the gas diffusion electrode as claimed in claim 33 as oxygen-depolarized electrode for the reduction of oxygen in an alkaline medium or as electrode in an alkaline fuel cell or as electrode in a metal/air battery.

42. An electrolysis apparatus comprising a gas diffusion electrode as claimed in claim 33 as oxygen-depolarized cathode.
